(19) United States
(12) Patent Application Publication
(10) Pub. No.: US 2004/0129121 A1
(43) Pub. Date: Jul. 8, 2004

(54) Method for scanning sheet-type work material and cutting pattern pieces therefrom

(75) Inventor: A. Bruce Plumley, Middletown, CT (US)

Correspondence Address: Richard R. Michaud, McCormick, Paulding & Huber LLP, CityPlace II, 185 Asylum Street, Hartford, CT, 06103, US

(73) Assignee: Gerber Technology, Inc., Tolland, CT

(21) Appl. No.: 10/629,174

(22) Filed: Jul. 29, 2003

Related U.S. Application Data
(60) Provisional application No. 60/399,212, filed on Jul. 29, 2002.

(51) Int. Cl. B26D 3/00

(52) U.S. Cl. 83/49

(57) ABSTRACT

In a method for scanning and cutting sheet-type work material carried on a support surface, the work material is automatically scanned to determine a periphery thereof and to allow for the detection of any flaws within the periphery of the work material. The layout of a marker is then established on the work material and a nesting process for pattern pieces is begun. A first pattern piece is nested onto the work material and a subsequent pattern piece is also nested onto the work material while the first pattern piece is simultaneously cut therefrom. These steps are repeated until all of the pattern pieces are cut from the work material.

### CROSS-REFERENCE TO RELATED APPLICATIONS

This application is entitled to the benefit of and incorporates by reference essential subject matter disclosed in Provisional Patent Application No. 60/399,212 filed on Jul. 29, 2002.

### FIELD OF THE INVENTION

The present invention is generally related to the cutting of pattern pieces from work material, and is more particularly directed to a method for simultaneously nesting and cutting said pattern pieces from the work material.

### BACKGROUND OF THE INVENTION

Patterns for making garments or upholstery are often referred to by those skilled in the pertinent art to which the present invention pertains as markers. When the pattern is to be cut from leather or another animal hide, knowledge of the peripheral shape of the hide as well as the location of any flawed areas within the hide itself is required. Accordingly, the layout or nesting of pattern pieces on the hide which comprise the marker will vary in both location and orientation from hide to hide dependent on the location of any flaws and the outer shape of the hide. Typically, such flaw detection and nesting is done manually and once the marker is laid out, the pieces can be cut either manually or automatically. Efforts have been made to automate this process, however, these have been limited to employing apparatus for scanning the entire hide and once the hide is scanned indicating the location of flaws and either automatically or manually positioning the pattern pieces onto the hide. Subsequent to laying out the entire marker, the individual pattern pieces are cut from the hide. The scanning and nesting operation is time consuming, as is the subsequent cutting operation. In addition, there can be a time lag between operation or the scanning, nesting and cutting operation can be complete on different machines. As such, there is a need in the garment and upholstery making industry for a method by which the time required to accomplish the above-described operation can be reduced. Even a 10% savings in processing time over the course of a fiscal year can result in significant economic gains for a manufacturer.

Based on the foregoing it is the general object of the present invention to overcome or improve upon the drawbacks and problems associated with the prior art.

### SUMMARY OF THE INVENTION

The present invention is directed in one aspect to a method for scanning and cutting pattern pieces from at least one layer of sheet-type work material wherein the work material is carried on a support surface having means for scanning the work material and cutting pattern pieces therefrom. The material is first presented to the support surface and the periphery and interior of the layer of work material is scanned to detect any flawed areas as well as the outer shape of the layer of work material. Once the scanning process is complete, pattern pieces are automatically nested onto the work material. Following the nesting of the first pattern piece, a cutting operation is initiated wherein the first pattern piece is cut from the layer of work material while the second pattern piece is nested. Once the second pattern piece has been nested, the cutting operation begins on it while the third pattern piece is nested. This process is continued until all of the pattern pieces have been nested and cut from the work material.

In a preferred embodiment of the present invention, a cutting table is provided that includes the above-described support surface. At least one carriage extends across the support surface and is movable therealong in response to commands issued from a controller back-and-forth in a first coordinate direction. A scanning head is mounted onto the carriage and is movable therealong back-and-forth in a second coordinate direction approximately perpendicular to the first coordinate direction. A cutting head is also mounted onto the carriage for movement back-and-forth in the second coordinate direction the movement of both the cutting head and the scanning head being coordinated by commands issued from the controller. While the scanning head and cutting head have been described as being mounted onto the same carriage, the present invention is not limited in this regard as separate carriages can be provided each being independently movable and having a respective one of the scanning and cutting heads mounted for movement thereon without departing from the broader aspects of the present invention. The cutting head includes a cutting tool mounted thereon for movement between a working position wherein the cutting tool engages and cuts the work material in a non-working position wherein the cutting tool is spaced away from the work material.

Preferably, the scanning head includes a scanning device in the form of a camera that transmits images of the layer of work material to the controller which is suitably programmed to evaluate the images to determine the location of peripheral edges and defects or flaws in the work material. While a camera has been described, the present invention is not limited in this regard as other types of scanning devices such as a thermal, infrared, or topographical scanners may be employed without departing from the broader aspects of the present invention.

An advantage of the present invention is that the nesting and cutting operations can be performed simultaneously thereby significantly reducing the amount of time it takes to cut pattern pieces corresponding to a marker from the work material.

Another advantage of the present invention is that flaw detection and cutting can be accomplished using a single apparatus thereby minimizing the amount of space required to complete a manufacturing process.

Still another advantage of the present invention is that the amount of personnel required to complete the above-described process is minimized since scanning and flaw detection as well as cutting operations are substantially automated and perform on a single apparatus thereby minimizing the number of machine operators required and hence further decreasing the cost for producing the pattern pieces that form a given article.

### BRIEF DESCRIPTION OF THE DRAWINGS

FIG. 1 is a perspective view of an apparatus useful in carrying out the method of the present invention.

### DETAILED DESCRIPTION OF THE PREFERRED EMBODIMENTS

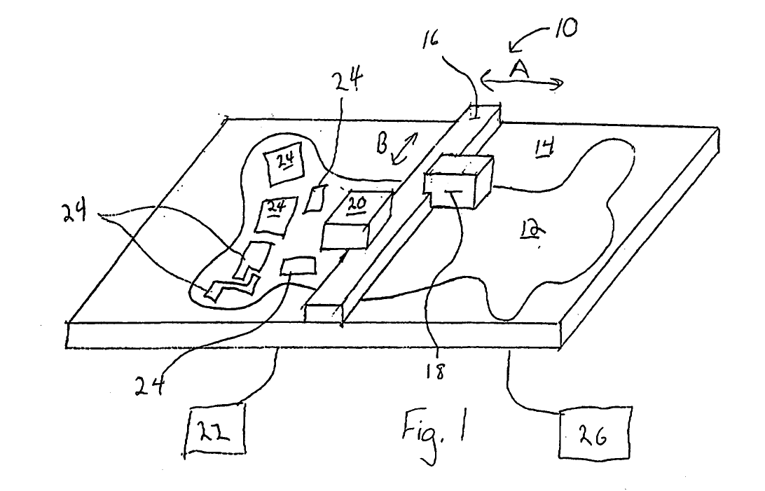

As shown schematically in FIG. 1, a scanning and cutting table, generally designated by the reference number 10, has a layer of sheet-type work material, shown in the illustrated embodiment as a hide 12, positioned on a support surface 14. The scanning and cutting table 10 includes a carriage 16 mounted for movement back-and-forth longitudinally of the cutting table in first coordinate direction indicated by the arrows labeled “A”. A scanning head 18 is coupled to the carriage 16 for movement back-and-forth along said carriage in second coordinate direction indicated by the arrows labeled “B”. The second coordinate direction is approximately perpendicular to the first coordinate direction. The scanning head 18 includes a suitable scanning device, such as, but not limited to a camera, for scanning the surface of the hide 12 to determine the hides perimeter, as well as the location of any defects in the surface of the hide. While a hide has been shown and described, the present invention is not limited in this regard as other materials such as fabric, rubber, vinyl, and the like can be substituted without departing from the broader aspects of the present invention.

In addition to the scanning head 18, a cuffing head 20 is also mounted to the carriage 16 and includes a suitable cutter, such as, but not limited to a reciprocating knife (not shown). Similar to the scanning head 18, the cuffing head 20 is movable back-and-forth along the carriage 16 in the second coordinate direction indicated by the arrow labeled “B”. The carriage 16, as well as the scanning and cutting heads, 18 and 20 respectively, are each controlled by commands issued from a controller 22.

During operation, the hide 12 is positioned on the support surface 14. The hide 12 is completely scanned by the scanning head 18 to determine the hide's periphery and the location of any defects. Subsequent to scanning, the controller 22 determines the location for the placement of individual pattern pieces 24 to be cut from the hide, a process referred to as nesting. Once the location of a nested pattern piece 24 is determined, and concomitant with the continued nesting of pattern pieces, the cutting head 20 cuts the pattern pieces whose location has been determined, from the hide. To aid in the cutting of the pattern pieces 24 from the hide 12, the hide can be drawn against the support surface 14 via vacuum supplied by a vacuum generator shown schematically at 26. To aid in the application of the vacuum, the peripheral edges of the hide 12 can be covered with a layer of impermeable material, such as a polymeric film. While the scanning and cutting heads, 18 and 20 respectively, have been shown and described as being mounted on a single carriage 16, the present invention is not limited in this regard as each of the scanning and cutting heads can be mounted on a separate carriage without departing from the broader aspects of the present invention.

What is claimed is:

1. A method for scanning and cutting sheet-type work material, said method comprising the steps of:
a) providing a layer of sheet-type work material carried by a support surface;
b) providing the means to automatically scan and cut said work material;
c) automatically scanning said work material to determine a periphery thereof, and to allow for the detection of flaws in said work material;
d) establishing the layout of a marker on said work material;
e) nesting a pattern piece onto said work material;
f) nesting a subsequent pattern piece onto said work material while simultaneously cutting the previously nested pattern piece from said work material; and
g) repeating steps e and f until all of said pattern pieces are cut from said marker.

2. A method as defined by claim 1, wherein:
said step of providing the means to automatically scan and cut said work material further includes:
providing a scanning and cutting table having, a frame, said support surface being mounted to said frame, a carriage mounted to said frame for movement back-and-forth in a first coordinate direction in response to commands issued from a controller; and wherein said step of providing the means to automatically scan and cut said work material includes:
providing a cutting head and a scanning head mounted on said carriage, each for movement independently of the other back-and-forth along the carriage in response to commands issued from the controller in a second coordinate direction approximately perpendicular to said first coordinate direction.

3. A method as defined by claim 1, wherein said work material comprises a hide.

4. A method as defined by claim 1 including the further step of providing a vacuum generator for drawing said work material against said support surface.

5. A method as defined by claim 4, further comprising the steps of:
providing a layer of impermeable material;
covering said work material with said layer of impermeable material; and
operating said vacuum generator to draw said work material and said layer of impermeable material down against said support surface.

6. A method as defined by claim 1, wherein said step of automatically scanning includes, automatically detecting said flaws in said work material.
